(19) United States
(12) Patent Application Publication
(10) Pub. No.: US 2007/0162948 A1
(43) Pub. Date: Jul. 12, 2007

(54) Personal video recorder apparatus providing an advertisement and method thereof

(75) Inventors: Jae-hak Kim, Gyeonggi-do (KR); Yong-sang Jeong, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/500,966

(22) Filed: Aug. 9, 2006

(30) Foreign Application Priority Data
Jan. 10, 2006 (KR) 10-2006-0002790

(51) Int. Cl. H04N 7/16; H04N 7/173; H04N 5/445; H04N 7/10; H04N 7/025; G06F 13/00; G06F 3/00

(52) U.S. Cl. 725/134; 725/142; 725/32; 725/42

(57) ABSTRACT

A personal video recorder (PVR) apparatus, in which an advertisement is provided, includes a broadcasting signal receiver to receive a broadcasting signal transmitted from a broadcasting station, an electronic program guide (EPG) analyzer to analyze EPG information included in the broadcasting signal, an editor to edit certain advertisement data according to the analysis result of the EPG analyzer, and an outputter to output the broadcasting signal received by the broadcasting signal receiver and the advertisement data edited by the editor. With such a PVR apparatus an advertisement can be provided that suits the characteristics of a user and is displayed to the user at a set time.

### BACKGROUND OF THE INVENTION

1. Field of the Invention

Apparatuses and methods consistent with the present invention relate to a personal video recorder (PVR) apparatus providing an advertisement. More particularly, these apparatuses and methods relate to a PVR apparatus that inserts an advertisement into a broadcast signal so as to display to a user, at a set time, an advertisement that is a useful to the user, and a method thereof.

2. Description of the Related Art

As digital broadcasting has become popular, not only have display apparatuses displaying a high definition image become widely spread, but so has a personal video recorder (PVR) apparatus that has a recording function. The PVR apparatus is a personal digital video recorder apparatus that records and reproduces a broadcasting signal to and from a high capacity hard disk. In more detail, the PVR apparatus can record a moving image without using a videocassette tape. In the case of digital broadcasting, the PVR apparatus can record a high definition moving image that is five times or more clearer than an analogue broadcast.

Accordingly, a digital broadcasting program can be stored and reproduced to appear like a live program and a plurality of programs can be simultaneously recorded using the PVR apparatus without having to use a reproducing apparatus such as a videocassette recorder (VCR). Additionally, since a broadcasting program is reproduced by using a file reproducing scheme, convenient functions such as fast reproducing speed, editing and repeated reproducing can be performed. Further, a viewing scheduled for watching a program can be organized according to a user's personal selection and preference so that the user can watch a desired program, such as a live program, when the user wishes.

FIG. 1 is a diagram for explaining a method for providing an advertisement for a conventional PVR apparatus.

Referring to FIG. 1, a conventional broadcasting station 10 transmits advertisement data together with broadcasting signals through an artificial satellite 20, a terrestrial station 30, or a cable network 40 to the PVR apparatus 50. The PVR apparatus 50 receives the broadcasting signals and advertisement data and processes them as signals to provide the signals to the display 60, so that broadcasting programs and advertisements are displayed on a display screen 60.

Currently, all viewers watch the same advertisements provided from the broadcasting station 10, including advertisements that are unrelated to or not interesting to a particular PVR apparatus user. Furthermore, a user can record broadcasting programs and advertisements using the PVR apparatus 50 and reproduce them as necessary. At this time, most viewers reproduce and watch only the broadcasting programs and exclude the advertisements by using a time shift function provided in the PVR apparatus 50. In other words, a viewer can arbitrarily delete the advertisements provided from the broadcasting station 10 in order to watch only the broadcasting programs. Therefore, the business model of the broadcasting station 10 is endangered and may disappear because advertisers may become less inclined to spend their advertising budgets on advertisements that users of PRV apparatus by-pass.

Accordingly, a need has arisen to solve problems generated when most of viewers must watch advertisements irrespective of their preferences or desire to skip the advertisements, and to support a market expansion of the PVR apparatus.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above. According to an embodiment of the invention, a personal video recorder (PVR) apparatus provides an advertisement so that a viewer can watch the advertisement at a set time in which the advertisement suits the sex and/or age of the viewer. A method for providing such an advertisement is also provided.

To achieve the above-described aspects, an embodiment of a personal video recorder (PVR) apparatus includes a broadcasting signal receiver to receive a broadcasting signal transmitted from a broadcasting station, an electronic program guide (EPG) analyzer to analyze EPG information included in the broadcasting signal, an editor to edit certain advertisement data according to the analyzing result of the EPG analyzer, and an outputter to output the broadcasting signal received by the broadcasting signal receiver and the advertisement data edited by the editor.

The EPG analyzer may analyze the EPG information to provide viewer information and time information as the analyzing result. The viewer information includes at least one of a sex distinction and an age of a viewer, and the time information corresponds to a viewing time band of a certain advertisement.

Referring to the viewer information, the editor edits the advertisement data corresponding to at least one of the sex distinction and age of the viewer to be inserted into the broadcasting signal output through the outputter.

Referring to the time information, the editor edits the advertisement data corresponding to the time information to be inserted into the broadcasting signal output through the outputter.

The apparatus may further include a broadcasting recorder in which the broadcasting signal is stored. According to the analyzing result of the EPG analyzer, the editor edits the advertisement data corresponding to at least one of the viewer information and the time information to be inserted into the broadcasting signal stored in the broadcasting recorder.

The apparatus may further include an advertisement data receiver to receive the advertisement data, and an advertisement storage unit to store the advertisement data. The advertisement data receiver may receive the advertisement data over an x-digital subscriber line (xDSL) network.

To achieve the above-described aspects, there is provided a method of providing an advertisement including operations of receiving a broadcasting signal transmitted from a broadcasting station, analyzing EPG information included in the broadcasting signal, editing certain advertisement data according to the analyzing result, and outputting the broadcasting signal and the edited advertisement data.

The operation of analyzing the EPG information is performed by analyzing the EPG information to provide viewer information and time information as the analyzing result. The viewer information includes at least one of a sex distinction and an age of a viewer, and the time information corresponds to a viewing time band of a certain advertisement.

The operation of editing the advertisement data is performed by editing the advertisement data based on at least one of the sex distinction and age of the viewer to be inserted into the broadcasting signal, referring to the viewer information.

The operation of editing the advertisement data is performed by editing the advertisement data based on the time information to be inserted into the broadcasting signal.

The method may further include storing the broadcasting signal.

The operation of editing the advertisement data is performed by editing the advertisement data corresponding to at least one of the viewer information and the time information to be inserted into the stored broadcasting signal according to the analyzing result of the EPG analyzer.

The method may further include operations of receiving and storing the advertisement data.

The operation of receiving the advertisement data can be performed by receiving the advertisement data over an xDSL network.

### BRIEF DESCRIPTION OF THE DRAWINGS

The above aspects and features of the present invention will be more apparent by describing certain embodiments of the present invention with reference to the accompanying drawings, in which:

FIG. 1 is a diagram for explaining a method of providing for an advertisement with a conventional PVR apparatus;

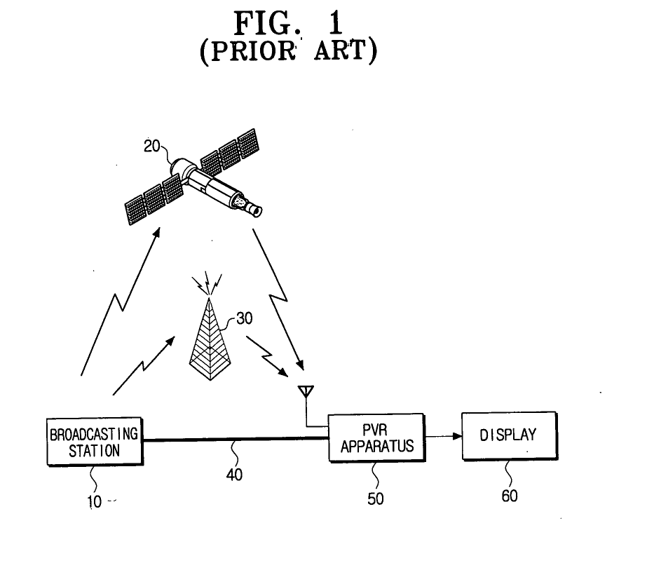

FIG. 2 is a diagram illustrating a schematic configuration of a PVR apparatus according to an exemplary embodiment of the present invention;

FIG. 3 is a diagram illustrating a business model to provide an advertisement to a user of a PVR apparatus according to an exemplary embodiment of the present invention; and

FIG. 4 is a flowchart of a method of providing an advertisement for a PVR apparatus according to an exemplary embodiment of the present invention.

### DETAILED DESCRIPTION OF THE EXEMPLARY EMBODIMENTS

Exemplary embodiments of the present invention will be described in detail with reference to the annexed drawings. In the drawings, the same elements are denoted by the same reference numerals throughout the drawings. In the following description, detailed descriptions of known functions and configurations incorporated herein have been omitted for conciseness and clarity.

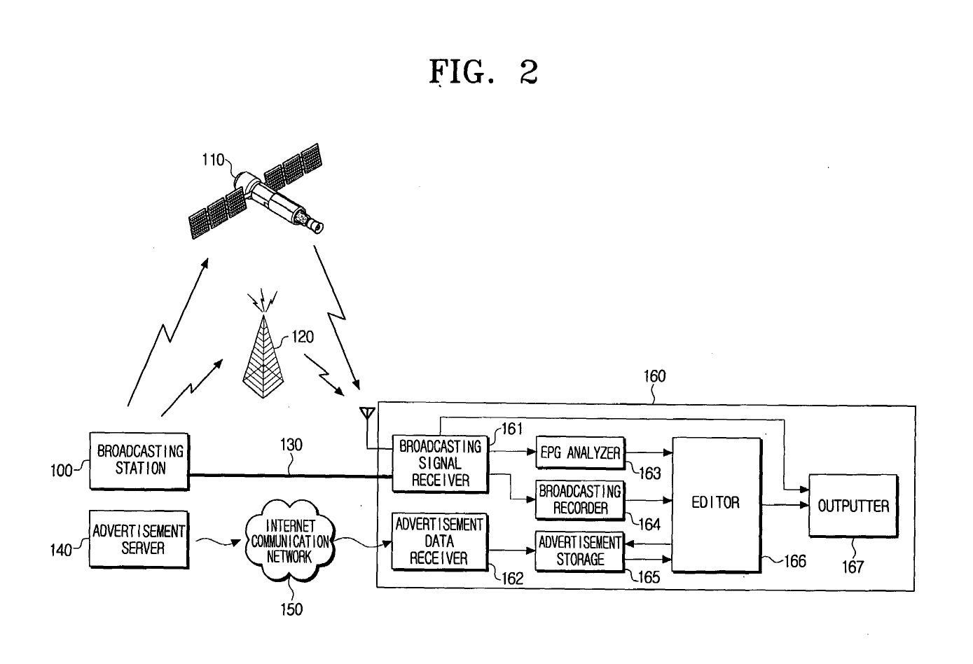

FIG. 2 is a view illustrating a schematic configuration of a personal video recorder (PVR) apparatus according to an embodiment of the present invention.

Referring to FIG. 2, a PVR apparatus 160 includes a broadcasting receiver 161, an advertisement data receiver 162, an electronic program guide (EPG) analyzer 163, a broadcasting recorder 164, an advertisement storage unit 165, an editor 166, and an outputter 167.

The broadcasting signal receiver 161 receives a broadcasting signal from an artificial satellite 110, a terrestrial station 120, and a cable network 130 carrying the signal output from a broadcasting station 100. Here, if the broadcasting signal receiver 161 is not capable of tuning a satellite broadcasting signal, terrestrial broadcasting signal or cable broadcasting signal, the broadcasting signal may be received through a set-top box (not shown) having the capability of tuning a satellite broadcasting signal, terrestrial broadcasting signal, or a cable broadcasting signal, respectively.

The advertisement data receiver 162 receives advertisement data over an Internet communication network 150 from an advertisement server 140. For the Internet communication network 150, an x digital subscriber line (xDSL) network may be used which employs a transmission scheme for a wideband subscriber network to obtain an additional high speed data line over an existing copper subscriber line. It will be understood by those skilled in the art that a variety of other types of communication networks can be used to deliver the advertisement data to the PVR apparatus 160.

The EPG analyzer 163 analyzes EPG information included in the broadcasting signal. The EPG information includes titles of programs broadcast from each channel, broadcasting times, and various information related to broadcast programs. The EPG analyzer 163 analyzes the EPG information to output viewer information such as information identifying the viewer's sex and age, and time information corresponding to the time a certain advertisement is to be viewed.

If the PVR apparatus 160 is operated in a recording mode, the broadcast signal received at the broadcasting signal receiver 161 is stored in a broadcasting recorder 164. Mainly, a hard disk is used for the broadcasting recorder 164 to store the broadcasting signal, and the broadcasting signal stored in the broadcasting recorder 164 is reproduced with a file reproducing scheme.

The advertisement data received at the advertisement data receiver 162 is stored in the advertisement storage unit 165. If an advertisement data request signal corresponding to a certain advertisement is received from the editor 166, which will be explained later, the advertisement storage unit 165 provides the advertisement data to the editor 166.

The editor 166 automatically edits and outputs advertisement data on the basis of the analysis of the result of the EPG analyzer 163. In more detail, when the PVR apparatus 160 is not operated in a recording mode, the broadcasting signal received through the broadcasting signal receiver 161 is processed as a signal by the outputter 167 to be output as video and audio. At this time, referring to the viewer information output from the EPG analyzer 163, the editor 166 requests the advertisement storage 165 for advertisement data corresponding to the sex or age of viewer. The editor 166 inserts the advertisement data that is provided from the advertisement storage unit 165, into the broadcasting signal that is output through the outputter 167 according to the time information output from the EPG analyzer 163.

Likewise, when the PVR apparatus 160 is operated in a recording mode, the editor 166 automatically inserts the advertisement data corresponding to the viewer information and the time information, into the broadcasting signal stored in the broadcasting recorder 164 to be output. In other words, the advertisement data corresponding to the sex or age of the viewer is received from the advertisement storage unit 165 according to the viewer information, and the advertisement data is inserted into the broadcasting signal according to the time information. The viewer information is obtained by analyzing the EPG information of the broadcasting signal stored in the broadcasting recorder 164.

When the PVR apparatus 160 is not operated in a recording mode, the outputter 167 outputs the advertisement data, which is output by the editor 166 according to the time information, as video and audio while outputting the broadcasting signal received at the broadcasting signal receiver 161 as video and audio. Additionally, when the PVR apparatus 160 is operated in a recording mode, the outputter 167 outputs the broadcasting signal and advertisement data output from the editor 166, as video and audio.

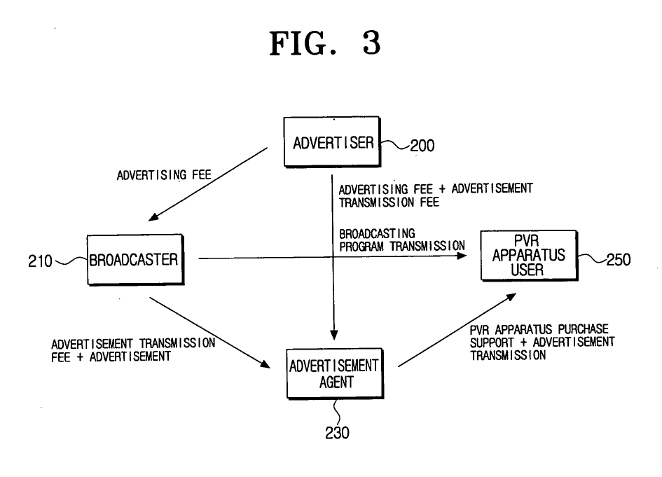

FIG. 3 is a view illustrating a business model to provide an advertisement to a user of a PVR apparatus according to an exemplary embodiment of the present invention.

Referring to FIG. 3, if an advertiser 200 pays an advertising fee to a broadcaster 210, the broadcaster 210 provides an advertisement and an advertisement transmission fee to an advertisement agent 230. Then, the advertisement agent 230 supports a PVR apparatus user 250 with money necessary for using the PVR apparatus 160, and transmits the advertisement to the PVR apparatus user 250. Also, the broadcasting program produced by the broadcaster 210 is transmitted to the PVR apparatus user 250.

Here, the advertisement agent 230 may receive the advertisement fee and the advertisement transmission fee directly from the advertiser 200. Parts of the advertisement fee and the advertisement transmission fee are used as supporting money for the PVR apparatus user 250 to purchase and use the PVR apparatus 160.

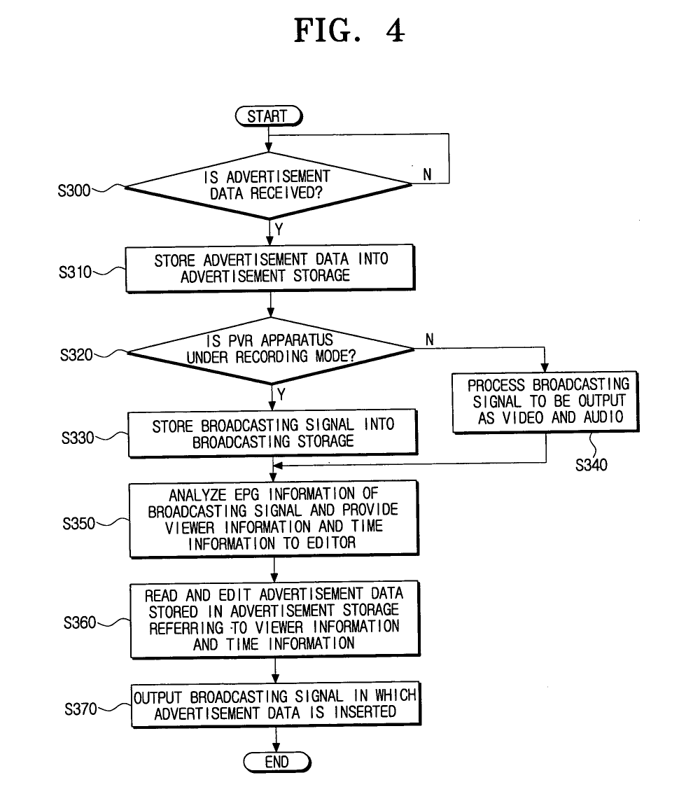

FIG. 4 is a flowchart of a method of providing an advertisement to a PVR apparatus according to an exemplary embodiment of the present invention.

Referring to FIG. 4, if the advertisement data transmitted from the advertisement server 140 is received over the Internet communication network 150 at the advertisement data receiver 162 (S300), the PVR apparatus 160 stores the advertisement data into the advertisement storage unit 165 (S310).

At this time, if the PVR apparatus 160 is operated in a recording mode (S320), the broadcasting signal received at the broadcasting signal receiver 161 is stored into the broadcasting recorder 164 (S330). Conversely, if the PVR apparatus 160 is not operated in a recording mode, the broadcasting signal received at the broadcasting signal receiver 161 is processed as an input signal by the outputter 167 to be output as video and audio (S340).

The EPG analyzer 163 analyzes the EPG information of the broadcasting signal received at the broadcasting signal receiver 161 to output viewer and time information to the editor (166) (S350). The viewer information corresponds to the sex and/or age of the viewer and the time information corresponds to the time band for displaying a particular advertisement.

Referring to the viewer information and the time information output from the EPG analyzer 163, the editor 166 reads and edits the advertisement data stored in the advertisement storage unit 165. In other words, advertisement data corresponding to the viewer information is selected and edited so that it is inserted into the broadcasting signal output from the outputter 167 according to the time information or it is inserted in the broadcasting signal stored in the broadcasting recorder 164 (S360).

Finally, the outputter 167 outputs the broadcasting signal in which the advertisement data is inserted (S370). According to this process, a proper advertisement according to the user's preference can be provided to the user.

As described above, if a PVR apparatus consistent with embodiments of the present invention is employed, the user of the PVR apparatus is shown an advertisement that suits the user's sex or age, at a set time, by using the analysis result of the EPG information. This results in the continued benefit of advertising and the market expansion for the PVR apparatus.

While the invention has been shown and described with reference to certain embodiments thereof, it will be understood by those skilled in the art that various changes in form and details may be made therein without departing from the spirit and scope of the invention as defined by the appended claims.

What is claimed is:

1. A personal video recorder (PVR) apparatus comprising:
a broadcasting signal receiver to receive a broadcasting signal transmitted from a broadcasting station;
an electronic program guide (EPG) analyzer to analyze EPG information included in the broadcasting signal;
an editor to edit advertisement data according to an analysis result of the EPG analyzer; and
an outputter to output the broadcasting signal received by the broadcasting signal receiver and the advertisement data edited by the editor.

2. The apparatus as claimed in claim 1, wherein the EPG analyzer analyzes the EPG information to provide viewer information and time information as the analysis result, the viewer information including at least one of an indicator of a viewer's sex and an age of the viewer, and the time information corresponds to a viewing time band for viewing an advertisement corresponding to the advertisement data.

3. The apparatus as claimed in claim 1, wherein the editor automatically edits the advertisement data.

4. The apparatus as claimed in claim 3, wherein, the editor edits the advertisement data based on at least one of the viewer's sex and viewer's age, for insertion into the broadcasting signal output by the outputter.

5. The apparatus as claimed in claim 3, wherein, the editor edits the advertisement data based on the time information for insertion into the broadcasting signal output by the outputter.

6. The apparatus as claimed in claim 3, further comprising:
a broadcasting recorder in which the broadcasting signal is stored,
wherein according to the analysis result of the EPG analyzer, the editor edits the advertisement data based on at least one of the viewer information and the time information for insertion into the broadcasting signal stored in the broadcasting recorder.

7. The apparatus as claimed in claim 1, further comprising:
an advertisement data receiver to receive the advertisement data; and
an advertisement storage unit to store the advertisement data.

8. The apparatus as claimed in claim 7, wherein the advertisement data is received over an Internet communication network.

9. The apparatus as claimed in claim 7, wherein the advertisement data receiver receives the advertisement data over a digital subscriber line (DSL) network.

10. The apparatus as claimed in claim 9, wherein the DSL network is an xDSL network.

11. A method of providing an advertisement comprising:
receiving a broadcasting signal transmitted from a broadcasting station;
analyzing electronic program guide (EPG) information included in the broadcasting signal to produce an analysis result;
editing advertisement data according to the analysis result; and
outputting the broadcasting signal and the edited advertisement data.

12. The method as claimed in claim 11, wherein the operation of analyzing the EPG information is performed by analyzing the EPG information to provide viewer information and time information as the analyzing result, the viewer information including at least one of an indication of a viewer's sex and an age of the viewer, and the time information corresponds to a viewing time band for viewing an advertisement.

13. The method as claimed in claim 11, wherein the editing of the advertisement data is performed automatically.

14. The method as claimed in claim 13, wherein the operation of editing the advertisement data is performed by editing the advertisement data based on at least one of the viewer's sex and age of the viewer, the edited advertisement data to be inserted into the broadcasting signal based on the viewer information.

15. The method as claimed in claim 13, wherein the operation of editing the advertisement data is performed by editing the advertisement data based on the time information, the advertisement data to be inserted into the broadcasting signal based on the time information

16. The method as claimed in claim 13, further comprising:
storing the broadcasting signal,
wherein the operation of editing the advertisement data is performed by editing the advertisement data based on at least one of the viewer information and the time information, the edited advertisement data to be inserted into the stored broadcasting signal according to the analysis result.

17. The method as claimed in claim 11, further comprising:
receiving the advertisement data; and
storing the advertisement data.

18. The method as claimed in claim 17, wherein the advertisement data is received over an Internet communication network.

19. The method as claimed in claim 17, wherein the operation of receiving the advertisement data is performed by receiving the advertisement data over a digital subscriber line (DSL) network.

20. The method as claimed in claim 19, wherein the DSL network is an xDSL network.
